(19) United States
(12) Patent Application Publication
(10) Pub. No.: US 2024/0279425 A1
(43) Pub. Date: Aug. 22, 2024

(54) Industrial depolymerization process of pet contained in artificial and natural fibres

(71) Applicants: Politecnico di Milano, Milano MI (IT); While True S.r.l., Seriate BG (IT)

(72) Inventors: Davide MOSCATELLI, Arese MI (IT); Giuseppe STORTI, Lodi LO (IT); Flavio TOLLINI, Bergamo BG (IT); Gianmarco POLOTTI, Sesto San Giovanni MI (IT); Lorenzo BRIVIO, Casatenovo LC (IT); Paolo INNOCENTI, Scanzorosciate BG (IT)

(21) Appl. No.: 18/568,877

(22) PCT Filed: Jul. 13, 2022
(86) PCT No.: PCT/IB2022/056461

§ 371 Date: Dec. 11, 2023

(30) Foreign Application Priority Data
Jul. 19, 2021 (IT) 102021000019076

(51) Int. Cl. C08J 11/24; C08J 11/16

(52) U.S. Cl. CPC C08J 11/24; C08J 11/16; C08J 2367/00

(57) ABSTRACT

Industrial depolymerization process of polyethylene terephthalate (PET) contained in artificial, natural and mixed dimethyl terephthalate (DMT) fibres by a first depolymerization of the PET in the presence of ethylene glycol and a catalyst (preferably sodium carbonate) to bis hydroxyethylene terephthalate (BHET), and subsequent transesterification of BHET solutions from the pressing of said artificial or natural fibres and from the washing of the same fibres.

This process is characterized in that:
in step a) the weight ratio of PET-containing fibres to ethylene glycol is between 0.3 and 4, preferably between 1.2 and 1.5;
step b) comprises a step b-1) of pressing the final mixture and a step b-2) of washing the fibres from b1) with methanol or with the post-crystallization recovery solution of DMT, and in step c) the transesterification is carried out on the BHET liquid solution from the pressing b-1) and on that also containing methanol from washing the fibres of step b-2).

Thereby, it is not necessary to concentrate the BHET solutions used in step c).

Further objects of the invention are the apparatuses for conducting the depolymerization, the pressing and washing step of the process of the invention.

### FIELD OF THE INVENTION

The present invention relates to a process for depolymerizing polyethylene terephthalate contained in natural and artificial dimethyl terephthalate fibres and related production systems for conducting certain steps of said process.

### BACKGROUND ART

Nowadays plastic is a subject of great controversy worldwide, on the one hand because of its cost-effectiveness, availability, ease of use and increasingly high technical quality, but on the other hand for reasons related to its massive environmental impact.

Several approaches are therefore being studied to reduce the production of virgin material and instead increase reuse, thus favouring plastic recovery and recycling. In particular, the most widespread recycling technologies can be classified into five macro-categories.
1. Zero-order recycling (direct reuse) of the product by the consumer, for example of bottles or containers initially containing drinks or food.

2. First-order recycling or plant recycling, for example unspecified product that is chipped and re-extruded to minimize production waste.

These first two systems are named in the literature as recycling systems, but are limited to reuse by users or manufacturers. The real recycling systems of plastics at the end of life, thus collected as waste at the end of life of the commercial product, are the remaining three.
3. Second-order recycling (or mechanical recycling):

The end-of-life product is used in new applications without changing its chemical structure by means of simple thermal-mechanical processes, for example extrusion, suitable for reprocessing the polymeric material for the production of new products. Given their advantages in terms of simplicity and cost-effectiveness, these processes form 80% of the quantities of PET currently recycled. On the other hand, the same processes exhibit great disadvantages such as the unavoidable degradation of the polymer due to the mechanical-heat treatment, the lack of a purification process of the material as additives and dyes, and the inability to extract and enhance the polymer fractions from complex matrices such as fibres, laminates, and composite materials.

To counteract the inexorable thermal degradation, second-generation mechanical recycling systems called super-clean have recently been created, which include a solid-state boosted re-polymerization process by vacuum to eliminate some volatile contaminants and thus ensure a food-grade polymer.

recoSTAR PETiV+ technology of Starlinger Recycling Company belongs to this new generation of recycling systems, which bases its decontamination on pellets, as well as the VACUREMA technology of Erema Plastic Recycling Systems, which bases its decontamination directly on flakes.

Although the mechanical processes tend to be simple and inexpensive due to the nature of the technology, the recycling system is intrinsically insufficient. In fact, the polymers that are produced cannot be recycled infinitely since the thermal degradation can only be partially compensated. Furthermore, the inability to remove dyes, heavy contaminants, and the existence of different types of plastics/materials (e.g., in the textile sector) limit such processes to transparent plastic bottles only (in the case of the super-clean processes) and to coloured plastic bottles that have passed the highest selection levels (in the event of simple extrusion).
4. Third-order recycling or chemical recycling

These processes involve the manipulation of the chemical structure of materials. In this case, processes are used that include the complete depolymerization of the plastic in order to re-obtain the starting monomers. It is therefore possible to purify the materials of various impurities, but complex chemical treatments and adequate systems are required. There are several technologies on the market with the important disadvantage of being operated only by large chemical companies in the field, the only ones able to manage such systems economically. Furthermore, the final product (the monomer) is usable to re-polymerize quality material only as long as it accepts further production costs.

The main existing technologies for the chemical recycling of PET are depolymerization for Hydrolysis, Methanolysis and Glycolysis which respectively use water, methanol and ethylene glycol to produce three different monomers. Such technologies currently cover the technological state of the art of the chemical recycling of PET. There are many variants of such technologies which exploit complex and articulated systems such as pressurized supercritical vapours reactors, microwaves, etc.
5. Fourth-order recycling or energy recovery

In this case, plastic is used as a fuel in combustion processes to produce electricity. The corresponding plants are called waste-to-energy plants. The same category also includes processes called “from waste to fuel” suitable for thermal decomposition through pyrolysis, gasification and cracking of polymeric materials for the production of fuels.

One of the problems of chemical recycling lies in depolymerizing the polymer from textile materials.

U.S. Pat. No. 5,236,959 describes a depolymerization process comprising a first depolymerization reaction in the presence of ethylene glycol and a catalyst, for example sodium carbonate at 200° C., which treats a cotton/polyester fabric (in particular polyethylene terephthalate). In this step, the formation of bis hydroxyethylene terephthalate (BHET) is obtained. The recovery of the BHET solution must be conducted hot, otherwise the BHET crystallizes on the fibres, and is performed by pressing the fibres and subsequent washing by addition of methanol.

The BHET solutions from the pressing and washing, respectively, are combined, added with alcohol, and then subjected to transesterification in the presence of a catalyst until the dimethyl terephthalate monomer is obtained, which once cooled crystallizes and is separated from the reaction mixture.

This process suffers from a considerable disadvantage that makes its use uneconomical in proceeding with the second transesterification: the recovered BHET solutions must be considerably concentrated after the depolymerization reaction, otherwise the subsequent transesterification reaction would not be effective.

As is known, the concentration of a solution at an industrial level involves a considerable energy expenditure caused by the evaporation of considerable volumes of solvent which must be disposed of and/or recycled.

It is therefore necessary to have an industrial depolymerization process that does not have the aforesaid drawbacks, but which at the same time can be modulated according to the needs not only of large industry, but also of small and medium-sized companies working in the sector.

CN110964188 A describes a production process of recycled polyester resin portions. The production method comprises the following steps: (1) pretreatment; (2) alcoholysis reaction; (3) polyester cotton separation; (4) BHET transesterification reaction; (5) DMT crystallization, separation, and grinding; (6) DMT transesterification reaction; (7) polymerization reaction; (8) pelleting. The recycled portions obtained by this process have excellent physical properties and excellent spinnability, can be used for the production and manufacture of polyester filaments, short fibres, non-woven fabrics, and the like, and for recycling waste resources.

WO2021004068 A1 relates to a polyester waste material recovery process, in particular to a method for preparing dimethyl terephthalate (DMT) by recovery of waste polyester with a chemical method and to the related technical field of waste polyester recycling. Continuous feeding and continuous alcoholysis processes are used to subject the material in the molten state to the homogeneous alcoholysis. The required alcoholysis time is short, more than two alcoholysis boilers are used in series to achieve continuous alcoholysis and the quality of the alcoholysis product is stable; furthermore, since the amount of EG used in the alcoholysis process is optimized, distillation and concentration is not required at the end of the alcoholysis step and the alcoholysis product enters directly into a transesterification boiler to undergo a transesterification reaction, generating pure DMT.

### SUMMARY OF THE INVENTION

The Applicant has now found that it is possible to overcome the drawbacks of the prior art with the process object of the present invention. This process comprises the following steps:
a) depolymerization of PET contained in artificial bis hydroxyethylene terephthalate (BHET) fibres at temperatures between 170 and 220° C. in the presence of ethylene glycol and a catalyst, preferably sodium bicarbonate, potassium bicarbonate, sodium carbonate, potassium carbonate, zinc acetate, titanium oxide, zinc oxide, calcium oxide, aluminium oxide, magnesium acetate, manganese acetate, sodium hydroxide, potassium hydroxide;
b) Recovery at a temperature between 100 and 170° C. of BHET and oligomers in EG solution.
c) Rejoining the BHET solutions from b) and transesterification to DMT of BHET in the presence of methanol and a catalyst of the same or different type than that used in the reaction mixture.

This process is characterized in that:
the depolymerization a) is carried out using a PET/ethylene glycol-containing fibre ratio between 0.3 and 4, preferably between 1.2 and 1.5;
step b) comprises a step b-1) of squeezing the final mixture and a step b-2) of washing the fibres from b-1) with methanol or with the post-crystallization recovery solution of DMT, and in step c) the transesterification is carried out on the BHET liquid solution from the squeezing b-1) and on that also containing methanol from washing the fibres of step b-2).
in step c) or in the second transesterification it is therefore not necessary to concentrate the BHET solutions used.

Thus, as a whole, the following results are obtained with the process according to the present invention:
1. Modularity: the process is completely modular and adaptable to various market needs.
2. Continuous operation: the process can operate continuously and can be placed near raw material collection stations or near the systems that use the polymer product in manufacturing processes.
3. Use of materials of very low value and which are difficult to reuse such as textile waste that would otherwise be destined for landfill or incineration.
4. Operation under mild conditions: in fact, the process operates at temperatures and pressures which are much more accessible with respect to the current processes available on the market, thus being much less energy intensive.
5. Low environmental impact: the process ensures a lower environmental impact with respect to the classic recycling systems, given the lower energy demand compared to the prior art, as underlined in point 4.
6. Upcycle/upgrade recycling possibility: unlike the currently available processes, this allows the monomer (DMT) to be purified to food-grade levels and allows it to be completely discoloured, therefore it is possible to obtain a food-grade polymer from waste with very low added value.

Further objects of the present invention are two types of apparatuses for conducting the first depolymerization reaction and the subsequent pressing and washing of the fibres obtained from the process of the invention.

### DESCRIPTION OF THE FIGURES

FIG. 1 depicts a perspective view of the first apparatus object of the present invention

FIGS. 2, 3 and 4 show perspective views of the first section of the first apparatus object of the present invention;

FIGS. 5 and 6 depict a perspective view of the second and third section of the first apparatus.

FIG. 7 depicts a profile view of the second apparatus object of the present invention.

FIG. 8 depicts a perspective and sectional view of the inner part of the second apparatus

FIG. 9 shows a block diagram or flow sheet of a preferred form of the process object of the present invention.

FIG. 10 depicts a block diagram of another preferred form for conducting the process of the invention.

FIG. 11 depicts the graph of the DMT transesterification kinetics using a weight ratio EG/MEOH=0.3, Solvent/BHET=20

FIG. 12 depicts the graph of the reaction kinetics using a weight ratio EG/MEOH=0.3, Solvent/BHET=8.

FIG. 13 shows the results of a study of the ratios between solvents and reagents in the BHET→DMT transesterification of the process object of the invention.

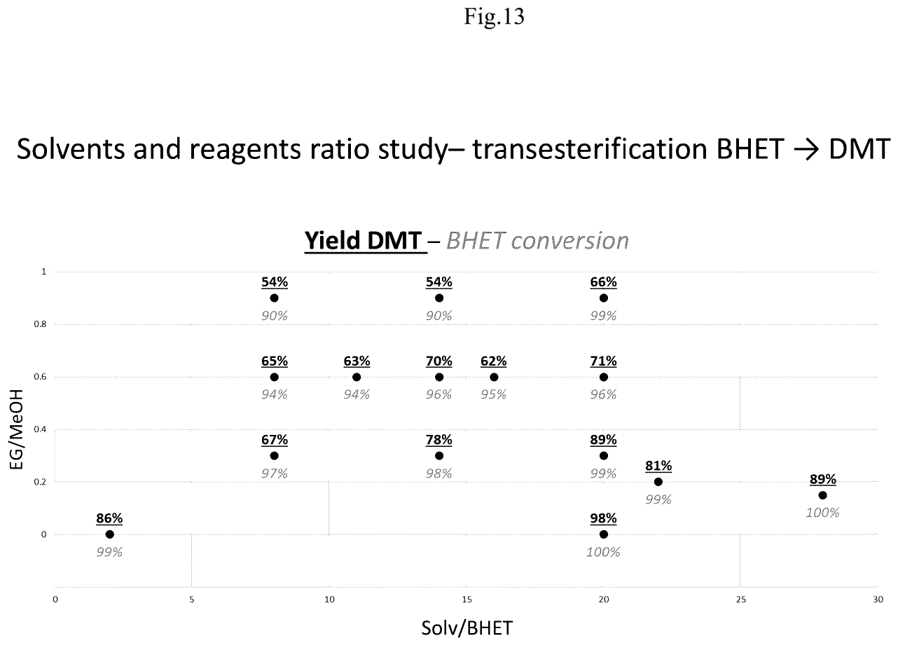

FIG. 14 shows the graph of the results obtained by operating under vacuum at 800 and 100 mbar respectively of the transesterification of DMT to BHET, intermediate stage for PET polymerization.

### DETAILED DESCRIPTION OF THE INVENTION

The process object of the present invention comprises:
a) Depolymerization of polyethylene terephthalate to bis hydroxyethylene terephthalate (BHET) in the presence of ethylene glycol and catalyst, preferably selected from: sodium bicarbonate, potassium bicarbonate, sodium carbonate, potassium carbonate, zinc acetate, titanium oxide, zinc oxide, calcium oxide, aluminium oxide, magnesium acetate, manganese acetate, sodium hydroxide, potassium hydroxide at temperatures between 170 and 220° C.;
b) Recovery at a temperature between 100 and 170° C. of BHET from the solutions of BHET and ethylene glycol;
c) Rejoining the BHET solutions from b) and transesterification to DMT of BHET in the presence of methanol and a catalyst of the same or different type than that used in the previous reaction;
d) Recovery and purification of the DMT monomer;
e) Re-polymerization of the DMT to PET with ethylene glycol from step d)
   in which
the depolymerization a) is carried out using a PET/ethylene glycol-containing fibre ratio between 0.3 and 4, preferably between 1.2 and 1.5
step b) of the process of the invention comprises a step b-1) of squeezing the final mixture and b-2) washing the fibres from b-1) with methanol. In step c), the transesterification is carried out on the liquid solution of BHET from the squeezing b-1) and on that also containing methanol from washing the fibres of step b-2);
step c) does not require a concentration of the BHET solution from step b)

According to a preferred embodiment of the invention, when the fibres from b-2) are still soaked with BHET, step b) comprises a further step b-3), in which said fibres are further subjected to a pressing step and in this case in step c) the BHET solutions from b-1) and b-3) are reacted.

To avoid the formation of considerable amounts of by-products, such as methyl hydroxyethyl terephthalate (MHET), in step “c” of transesterification of the process according to the present invention, the ethylene glycol/methanol ratio is between 0 and 0.9 (preferably between 0.01 and 0.3) and the ratio of solvent to BHET is between 8 and 20, preferably between 10 and 15.

Unlike what is reported in the aforementioned US patent, according to which for the separation of DMT it was necessary to cool the reaction mixture and filter the DMT from the reaction mixture, with the process of the invention the DMT recovery, preferably in addition to the crystallization and relative filtration contemplated in the US patent, which in step d) of the process of the invention is step d1, also comprises the following steps:
d-2) washing the precipitate obtained in d-1) with methanol;
d-3) drying the washed precipitate in d-2) and the related melting;
d-4) vacuum distillation of the molten DMT from step d-3).

Preferably, the methanol used in step d-2) is recycled with the exception of a purge at step b-2).

The DMT thus obtained can be immediately allocated for polymerization, or it can be stored and re-polymerized in separate systems.

Preferably the re-polymerization comprises:
e-1) hot and vacuum transesterification, where any residual methanol is removed and BHET is obtained,
e-2) polymerization of BHET and any oligomers present,

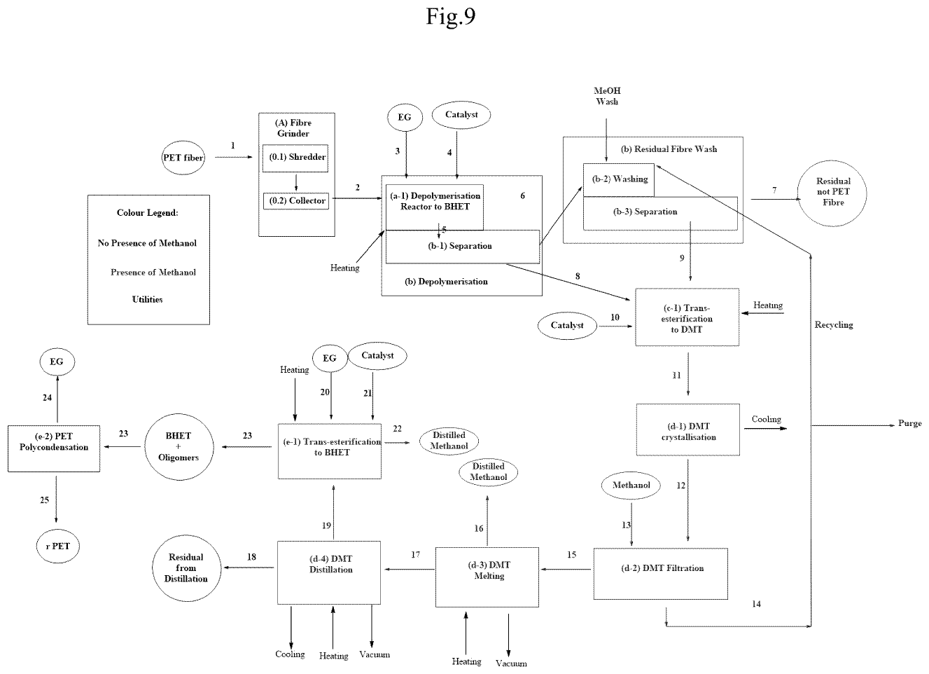

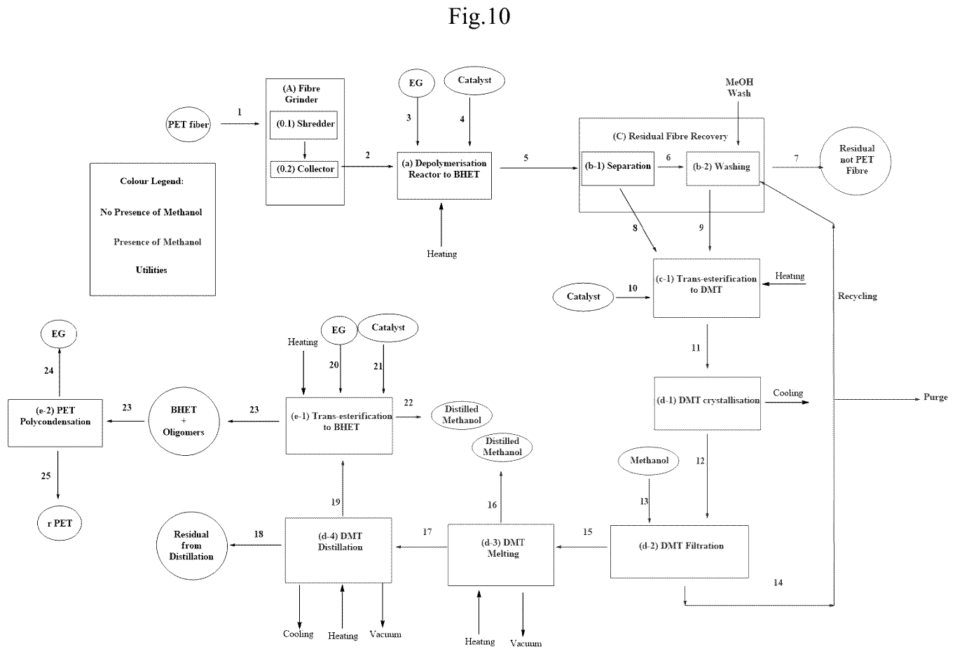

FIGS. 9 and 10 show two particularly preferred solutions for conducting the process according to the present invention.

In FIG. 9 the ground PET fibres by means of the line (2) are sent to section a) where in reactor a-1) (fed with ethylene glycol (EG) by means of the line (3) and with catalyst by means of the line (4)), the depolymerization is conducted. The reaction mixture obtained in this reactor is then sent to the separation section b) where the fibres are squeezed and the BHET produced in the reaction is sent to the transesterification section c-1) by means of the line (8). The squeezed fibres are washed with methanol in section b), formed by section b-2) where the washing of the fibres occurs and section b-3) where the PET-free residual fibres are separated and exit the separator by means of the line (7), while the methanol and BHET solution passes by means of the line (9) to the transesterification reactor c-1), fed as already underlined with BHET by means of the line (8) exiting the separator b-3) and by means of the catalyst line (10). The reaction mixture then passes to the cooling crystallization section d-1) by means of the line (11), where the DMT monomer precipitates. The mixture obtained is then sent to the filtration section d-2) by means of the line (12). Fresh methanol is added in this section by means of the line (13). The crystallized monomer is sent to the melting section d-3), by means of the line (15), while the filtered solution, with the exception of a purge, is sent by means of the line (14) to the washing section b-2). The precipitate is melted in the DMT melting section b-3), while the methanol still retained in the solid is evaporated and exits the line (16). The molten product passes to the vacuum distillation section where the DMT, once distilled, exits by means of the line (19) and is sent to the transesterification section e-1) fed with ethylene glycol EG by means of the line (20) and with catalyst by means of the line (21). The methanol formed in this section is removed with the line (22), while the resulting products consisting of BHETs and oligomers are sent with the line (23) to the polycondensation section e-2) fed with ethylene glycol by means of line (24) where the re-polymerization occurs. The recycled PET exits this section from the line (26).

The process diagram shown in FIG. 10 differs only in that section a) is formed by the reactor a-1) only while section b) contains a first separation section “b-1” where the reaction mixture is separated into a liquid phase (8) which is sent to the transesterification reactor c-1), while the solid phase is sent with the line (6) to the washing section b-2), where at the end of the washing the fibres are removed by means of the line (7), while the liquid phase (9) is sent to the transesterification reactor without being subjected to a distinct separation phase as is the case in the process diagram shown in FIG. 9.

A further object of the present invention is the two apparatuses for carrying out the process of the invention, for conducting depolymerization step a) and step b), in particular step b-1) of the present invention.

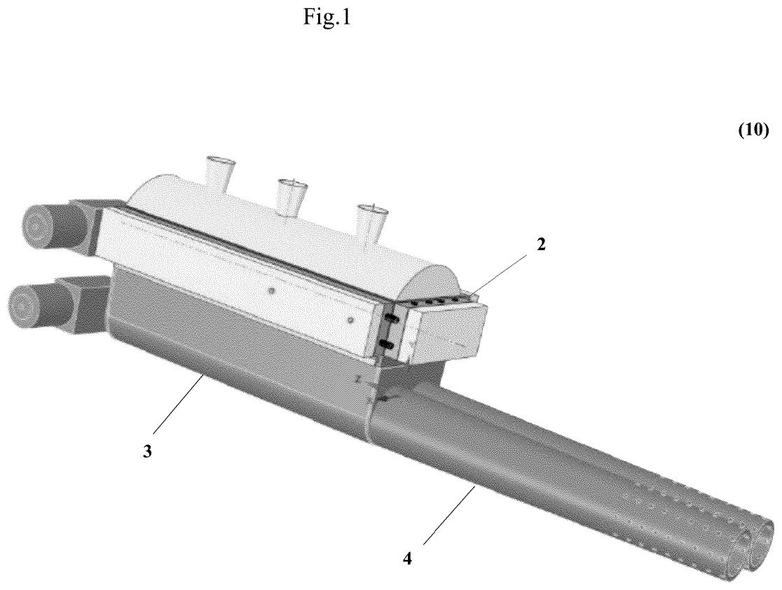

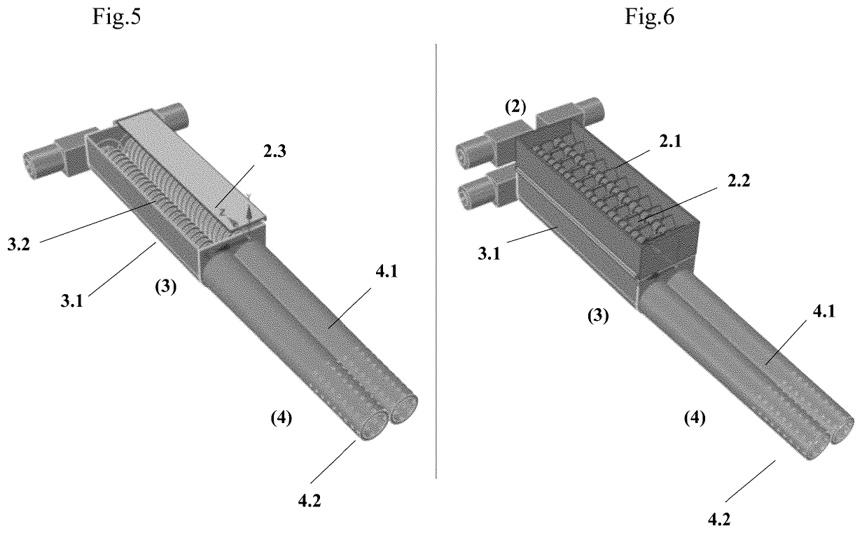

The first apparatus (10), shown in a preferred embodiment in particular in FIGS. 1-6, consists of:
A first section (2) comprising a reactor (2.1), a mechanical stirrer (2.2), heating means (2.4), thermal insulation means (2.5), a removable cover (2.7) provided with at least 3 inlets for loading the reagents and mounting possible reflux condensers (2.6); and a retractable movable bulkhead (2.3) which is automatically opened upon completion of the reaction;
A second underlying section (3) arranged along the direction parallel to that of the direction of the first section (2). This second section is in direct contact with the first and, once the bulkhead (2.3) is opened, it is in fluid and solid communication with the first section. The second section (3) comprises an insulated chamber (3.1) and a double auger (3.2) capable of moving the solid;
A third section (4) arranged along the same direction as the second section (3) and in fluid and solid communication with said second section (3), comprising two open tubes (4.1) at the end opposite that of the section (3) and provided at the same end with through holes (4.2), each of said tubes containing inside a double auger with reduced pitch and clearance with respect to those of the double auger present in the second section (3).

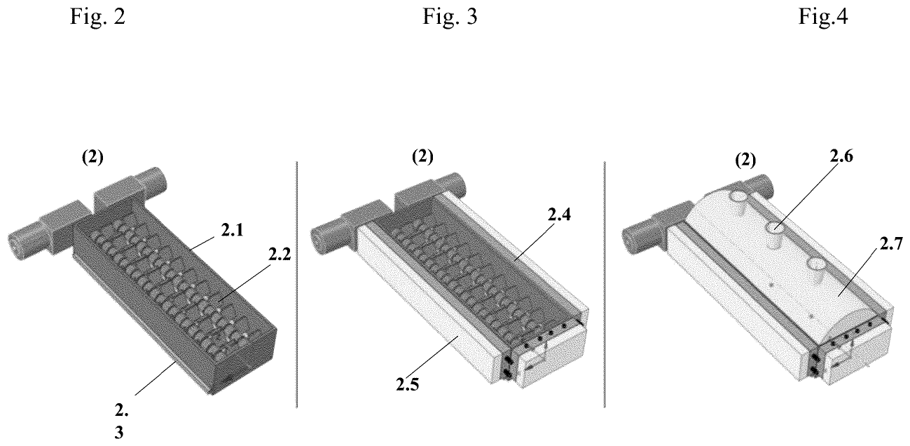

According to the solution shown in FIG. 1, the reactor (2.1) is arranged horizontally and consequently the section 2 containing it and the other sections 3 and 4 are arranged horizontally with respect to the support plane. Also in the preferred embodiment shown in FIGS. 2, 3 and 6, the mechanical stirrer (2.2) is with multiple blades and double shaft.

In this apparatus, steps “a” and “b-1” are preferably carried out as follows:
i) the fibres containing PET are loaded through one of the inlets 2.6 arranged on the removable cover (2.7), while ethylene glycol and catalyst are respectively loaded through the remaining two openings,
ii) at the end of the reaction the bulkhead (2.3) is opened, and thereby the reaction mixture containing the solid fibres, the BHET, any oligomers and ethylene glycol precipitates in the second section 3;
iii) by means of the double auger, the reaction mixture is sent towards the third section (4) where the actual pressing occurs inside the tubes (4.1) provided with a double auger iv) the liquid exiting from the holes (4.2) is collected and sent to step c), while the fibres exiting from the third section (4) are sent to step b-2) of washing with methanol.

If the fibres are still rich in BHET, they can be subjected to a further step b-3) which is carried out in said apparatus 10 which in this case comprises the following operating modes:
I) the first section is supplied with the fibres from the washing b-2) and supplied with methanol at temperatures between 20 and 60° C.
II) once the bulkhead is opened, the washing mixture passes into the second and then into the third section, provided with augers with greater clearance and pitch with respect to those of the second and third sections when used for steps a) and b-1) and given the greater amount of liquid present.

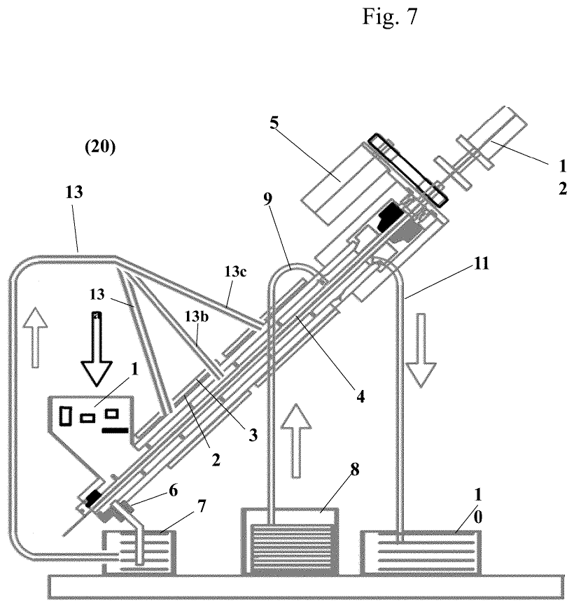

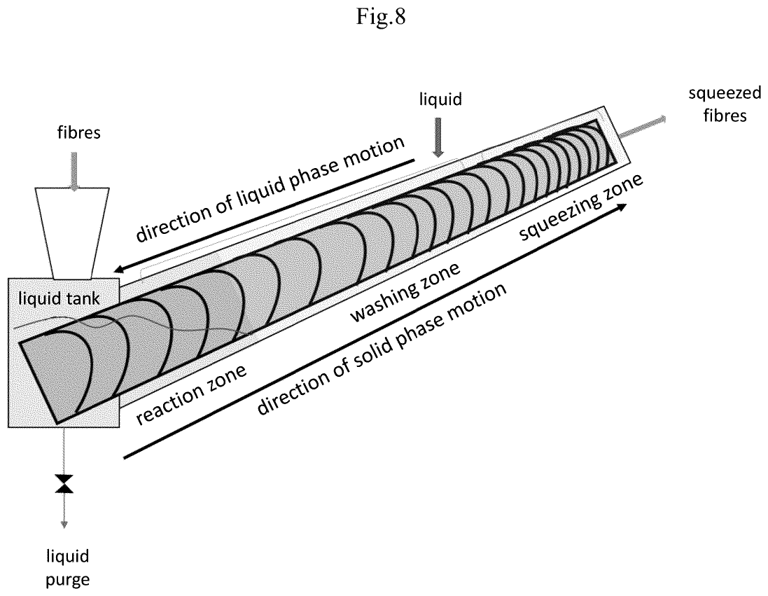

A further object of the present invention is the apparatus depicted in FIGS. 7 and 8.

It is arranged in an inclined position with respect to the support plane of an angle between 15 and 70°, preferably between 30 and 60°, comprises:
A) a cylindrical-shaped reactor (3) comprising:
   a double auger (4) arranged along the axis passing through said reactor and driven by a motor (5) outside said system,
   in the lower part, a hopper (1) for loading the solid reagents and an outlet (6) where the reacted liquid solution is unloaded into the tank (7) through a special line;
   in the upper part: an inlet through which the hot ethylene glycol taken from the tank (8) is pumped into the reactor (3) by means of the line (9), and an outlet arranged just above such inlet, through which the washed and pressed fibres exit by means of the line (11).
   at the top, there may be multiple inlets for the recycling system, FIG. 7 shows merely by way of example only three inlets (13a, 13b, 13c), preferably at least 5, more preferably at least 10, placed near the inlet of the line (9) through which the ethylene glycol and recycling BHET solution taken from the tank (7) is pumped into the reactor. The recycling system can be mixed with the line (9) of pure EG and inserted into the reactor in the upper section.
B) a compressor (12) to ensure the correct pressing of the fibres and the correct filling of the reactor (3),
C) heating and insulation means (2) which completely cover the side walls of the reactor (3) with the exception of:
I) hopper (1);
II) outlet through which the washed and pressed fibres exit by means of the line (11).

Steps a) and b-1) are carried out in this second system according to the following operating methods:
i) the fibres containing the PET are loaded into the reactor by means of the hopper (1) and the ethylene glycol and the catalyst are loaded by means of the line (9).
ii) in this lower zone (defined as a reaction zone) the fibres containing loaded PET come into contact with an accumulation of EG and BHET so as to be optimally wetted and so as to facilitate the depolymerization reaction;
iii) the depolymerized fibres are collected from the reaction zone and washed in the upper washing area in countercurrent with hot EG and already enriched with the catalyst, allowing not only to wash the fibres but also to complete the depolymerization reaction;
iv) the washed fibres are then squeezed in the squeezing zone, located at the upper end of the apparatus arranged under the compressor 12, before exiting the reactor (3) by means of the line (11).

The following examples of the process object of the present invention are given for illustrative but non-limiting purposes.

### Example 1—Depolymerization

16 g of mixed cotton and PET fibres (40/60) were placed in a 250 mL 3-neck flask together with 30 g of ethylene glycol and 0.05 g of Na₂CO₃ catalyst. The flask was inserted in a heating mantle, insulated with a layer of glass wool, and equipped with a mechanical stirrer and a reflux condenser. The rotation speed of the stirrer was set to 50 rpm and the reaction was carried out for a time of 2 h at atmospheric pressure and 200° C., i.e., the boiling temperature of the liquid ethylene glycol.

Other tests were conducted by reducing the ratio of ethylene glycol to fed fibres, reaching a ratio of 1.25 or 16 g of fibres in 20 g of ethylene glycol. In any case, the amount of ethylene glycol used is always much higher than the stoichiometric value, as it is necessary to effectively wet all the fed fibres.

In any case, at the end of the 2 h reaction, a complete depolymerization of the polyester fraction of the fed fibres is obtained, with a prevalence of the BHET monomer with respect to the oligomers (dimers and trimers in particular). By reducing the amount of ethylene glycol used, which, as mentioned, is in any case much higher than the stoichiometric value, a greater presence of oligomers (BHET2, BHET3, BHET4) was observed at the expense of the monomer (BHET1).

| EG vs fibres | depolymerization | BHET 1 | BHET 2 | BHET 3 | BHET 4 |
|---|---|---|---|---|---|
| 1.25 | 100% | 64% | 28% | 6% | 2% |
| 2 | 100% | 75% | 22% | 3% | 0% |

### Example 2—Squeezing

The product of the depolymerization reaction, having a temperature of 200° C., was immediately squeezed with a rudimentary pressure filter so as to keep the temperature as high as possible during the filtration operation. As expected, the product obtained was found to consist of BHET monomer and its oligomers thereof (dimer and trimer).

The fibre pressing procedure, although still in development, has made it possible to recover a significant amount of product, even more than the case in which it has not been implemented, thus giving the possibility of halving the number of subsequent washes to which the fibres must be subjected.

### Example 3—Washing

The residual fibres still impregnated with the BHET product were then re-inserted into the reaction flask, to which 90 g of methanol were added. The whole was then heated again to 50° C. to allow the BHET product to be more easily solubilized in the methanol solvent. The mixture was placed under mechanical stirring for 5 min in the same configuration adopted for the previous depolymerization reaction and subsequently unloaded and subjected to the same pressing procedure as previously adopted.

As already mentioned, the washing procedure in methanol is crucial in order to maximize the BHET product recovery, and even more so considering that the methanol solvent will itself be the reagent for the next reaction in the process diagram.

| test description | recovered product |
|---|---|
| no pressing - 2 washes | 86% |
| no pressing - 1 wash | 59% |
| no pressing - 0 washes | 0% |
| yes pressing - 2 washes | 100% |
| yes pressing - 1 wash | 92% |
| yes pressing - 0 washes | 31% |

### Example 4—Transesterification No. 1 to DMT

The solutions obtained from the pressing and washing units were combined and fed, together with 0.05 g of Na₂CO₃ catalyst, into a 250 mL two-neck flask. In this case, the reagent mixture contains 30 g of ethylene glycol, 90 g of methanol, 0.05 g of catalyst and a percentage (greater than 90%) of the BHET product of the depolymerization reaction (approximately 10-12 g).

The flask was put in an oil bath, equipped with a magnetic stirrer and provided with a reflux condenser. The rotation speed of the stirrer was set to 50 rpm and the reaction was carried out for a time of 90 min at atmospheric pressure and 72° C., i.e., the boiling temperature of the mixture.

Other tests were conducted by simulating the operation of the process as a whole, i.e., using the solution recovered downstream of the next filtration unit as the fibre washing solution (after their first pressing). In doing so, the ethylene glycol content of the reagent mixture progressively increased until reaching a plateau, whereby the ratio of ethylene glycol to methanol went from the value of 0.3 to that of 0.5.

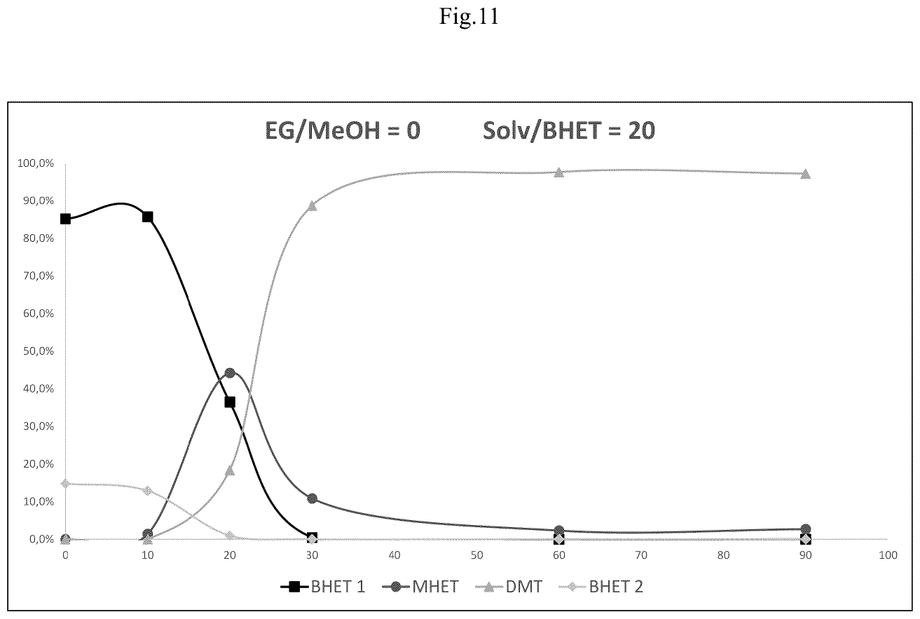

The transesterification reaction occurs with consumption of methanol and formation of ethylene glycol, so the best conditions to conduct it would be to have no ethylene glycol in the reagent mixture, in which case the reaction kinetics are those in the graph of FIG. 11.

Ideally, the minimum amount of ethylene glycol present in the reagent mixture is precisely that used in the depolymerization reaction. In reality, the ethylene glycol content of the mixture fed to this reactor is always higher considering that the fibres are washed with the recycling stream (containing ethylene glycol) and not with fresh methanol.

An exhaustive study was then carried out to verify the influence of the ratio of solvent to monomer and that of ethylene glycol to methanol so as to identify the best combination of recycling ratio and amount of fresh methanol to be used in the washing of fibres in terms of costs and yield in the DMT monomer.

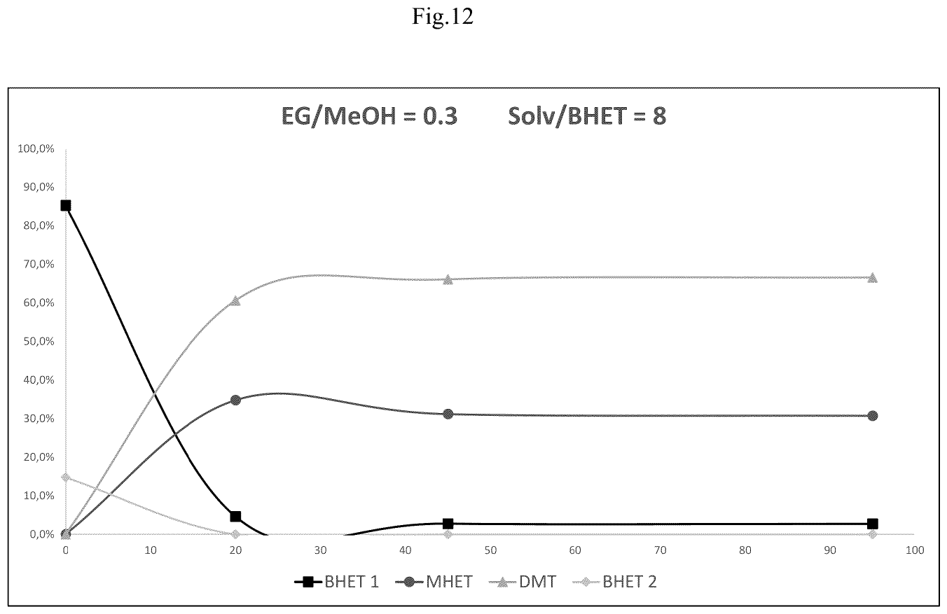

As an example, in one of these tests, the transesterification reaction was carried out on a mixture consisting of 13.85 [g] methanol, 4.15 [g] ethylene glycol, 2.25 [g] BHET monomer and 0.0054 [g] Na₂CO₃ catalyst. The BHET monomer used in these tests was purchased from Sigma Aldrich. The kinetics of this test are shown in FIG. 12. Unlike DMT, the possibly formed methyl hydroxyethyl terephthalate (MHET) does not precipitate but remains in solution, and is recycled during the washing of the fibres and is then sent back to the transesterification where it will partially react to DMT.

### Example 5

### Experimental Configuration:

A more in-depth study was conducted to assess how DMT yields vary in the transesterification reaction as the EG/MeOH and solvent/BHET ratios vary.

### Example 6—Crystallization

### Experimental Configuration:

The product of the transesterification reaction was then crystallized: the configuration previously used for transesterification remained virtually unchanged, except for the oil bath which was replaced by a water bath. In fact, the reaction flask was not unloaded but simply cooled and maintained at a temperature of 15 [° C.] for a time of 30 [min]. This allowed the DMT monomer to crystallize and then be separated from the mother liquor by filtration.

### Example 7—Filtration

### Experimental Configuration:

The mixture resulting from the previous crystallization unit is liquid with DMT monomer crystals dispersed therein. By means of a Buchner filtration apparatus (vacuum), and using a filter paper with pores of 20 [μm], the DMT crystals were then separated from the stock solution consisting mainly of methanol and ethylene glycol. This solution will then be recycled in the process (as a fibre washing solution after depolymerization and first pressing). The DMT crystals were then washed with 10 [g] fresh methanol.

### Results:

The combined crystallization and filtration procedure resulted in an efficiency between 86% and 91%

| test no. | DMT - crystals | DMT - mother liquor |
|---|---|---|
| 1 | 89.9% | 10.1% |
| 2 | 88.5% | 11.5% |

### Example 8—Distillation

### Experimental Configuration:

20 [g] of the still variously contaminated solid crystals from the previous filtration unit were fed into a 100 [mL] single-neck flask. The flask was placed in a heating mantle and equipped with a condenser to allow the distilled product to be separated from the reaction environment. The condenser was operated as a distillation column, and was carefully insulated with glass wool in order to try to maintain a temperature greater than 140 [° C.] in the upper part as well (i.e., the one farthest from the heating mantle and therefore colder). All the distillation had to be carried out above the temperature of 140 [° C.], this being the solidification temperature of the DMT monomer. To help maintain this temperature, a heat gun set at the temperature of 200 [° C.] was used and pointed towards the upper part of the condenser. The product (purified DMT) was then conveyed into a collection flask where it was readily solidified. The heating mantle was instead set at 350 [° C.], a temperature above the boiling point of the DMT monomer, so as to allow its boiling.

### Example 9—Transesterification No. 2 (to BHET)

### Experimental Configuration:

20 [g] of the distillation unit product (high purity DMT) were fed into a 100 [mL] flask with 3 necks together with 19.18 [g] of ethylene glycol (molar ratio of DMT to ethylene glycol of 0.67) and 0.33 [g] of zinc acetate catalyst. The flask was placed in an oil bath, equipped with a magnetic stirrer and provided with a Steglich condenser, which allowed the methanol produced during the reaction to be separated and pushed until complete conversion. The rotation speed of the stirrer was set to 50 [rpm] and the reaction was conducted in two steps. Initially, for a time of 60 [min], at atmospheric pressure and 180 [° C.], and then for another 30 [min] gradually and linearly lowering the pressure up to 100 [mbar] while keeping the bath temperature fixed, in order to push the reaction and also evaporate the excess ethylene glycol.

### Results:

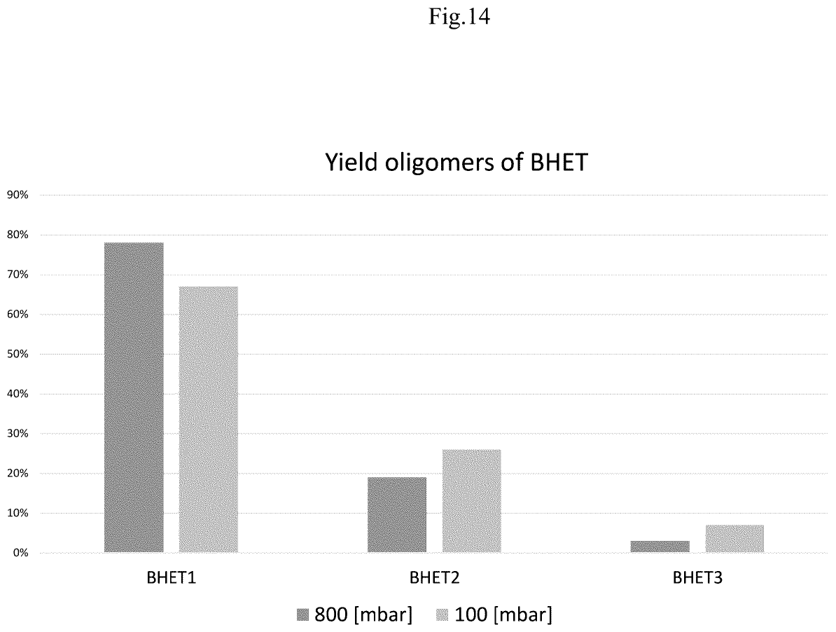

The reaction, pushed at pressures below atmospheric pressure, leads to 2 positive results: it firstly allows to also separate the excess ethylene glycol, and secondly leads to the formation of a relevant fraction of BHET oligomers (mainly dimers and trimers) as highlighted in FIG. 14, so as to reach a pre-polymerization step.

1. Process for depolymerizing polyethylene terephthalate (PET) contained in dimethyl terephthalate (DMT) fibres and relative re-polymerization to PET comprising:
Depolymerization of polyethylene terephthalate to bis hydroxyethylene terephthalate (BHET) and its oligomers thereof in the presence of ethylene glycol at temperatures between 170 and 220° C. and in the presence of a catalyst;
b) Recovery at a temperature between 100 and 170° C. of BHET and oligomers in EG solution;
c) Rejoining of the BHET solutions from b) and transesterification to DMT of BHET in the presence of methanol and a catalyst of the same or different type used in the reaction mixture
d) Recovery of the DMT from step c)
e) Re-polymerization of the DMT to PET with ethylene glycol from step d)
wherein
the depolymerization a) is carried out using a PET/ethylene glycol-containing fibre ratio between 0.3 and 4;
step b) comprises a step b-1) of squeezing the final mixture from step a) and a step b-2) of washing the fibres from b-1) with methanol or with the post-crystallization recovery solution of DMT, and in step c) transesterification is carried out on the BHET liquid solution from squeezing b-1) and on that also containing methanol from washing the fibres from step b-2);
step c) does not require a concentration of the solution from step b)

2. Process according to claim 1, wherein when the fibres from b-2) are still soaked with BHET, step b) comprises a further step b-3), wherein said fibres are further subjected to a pressing step and in this case in step c) the BHET solutions from b1) and b3) are reacted.

3. Process according to claim 1, wherein in step c) of transesterification the ethylene glycol/methanol ratio is between 0 and 0.9, while the ratio of solvent to BHET is between 8 and 20.

4. Process according to claim 1, wherein the step of recovering DMT comprises:
d-1) crystallization of DMT and related filtration;
d-2) washing the precipitate obtained in d-1) with methanol;
d-3) drying the washed precipitate in d-2) and related melting;
d-4) vacuum distillation of the molten DMT from step d-3).

5. Process according to claim 4, wherein the methanol used in step d-2) is recycled with exception of a purge at step b-2).

6. Process according to claim 1, comprising the step of re-polymerizing the DMT from step d) by ethylene glycol treatment and in the presence of a catalyst.

7. Process according to claim 6, wherein the repolymerization comprises:
e-1) hot transesterification, where any residual methanol is removed and BHET is obtained,
e-2) polymerization of BHET and any oligomers present.

8. Apparatus (10) consisting of:
A first section comprising a reactor, a mechanical stirrer, heating means, thermal insulation means, a removable cover provided with at least one inlet for loading the reagents and a retractable movable bulkhead which is automatically removed upon completion of the reaction,
A second section below, arranged along the direction parallel to that of the direction of the first section (2), placed in direct contact with said first section and, once the aforementioned bulkhead has been removed, being in fluid and solid communication with said first section; said second section comprising an insulated chamber, and a double auger capable of moving the solid;
A third section arranged along the same direction as the second section and in fluid and solid communication with said second section, comprising two open tubes at the end opposite that of the section and provided at the same end with through holes, each of said tubes containing inside a double auger with reduced pitch and clearance with respect to those of the double auger present in the second section.

9. Apparatus according to claim 8, wherein the reactor is arranged horizontally and consequently the section containing it and the other sections are arranged horizontally with respect to the support plane of said system.

10. Apparatus according to claim 8, wherein the mechanical stirrer is multiple-blade and double shaft.

11. Process according to claim 1, wherein step a) and step b-1) are carried out in an apparatus: consisting of:
A first section comprising a reactor, a mechanical stirrer, heating means, thermal insulation means, a removable cover provided with at least one inlet for loading the reagents and a retractable movable bulkhead, which is automatically removed upon completion of the reaction,
A second section below, arranged along the direction parallel to that of the direction of the first section, placed in direct contact with said first section and, once the aforementioned bulkhead has been removed, being in fluid and solid communication with said first section; said second section comprising an insulated chamber, and a double auger, capable of moving the solid;
A third section arranged along the same direction as the second section and in fluid and solid communication with said second section, comprising two open tubes at the end opposite that of the section and provided at the same end with through holes, each of said tubes containing inside a double auger with reduced pitch and clearance with respect to those of the double auger present in the second section;
said process comprising the following operating conditions:
i) the fibres containing PET are loaded through one of the inlets arranged on the removable cover, while ethylene glycol and the catalyst are respectively loaded through the remaining two openings,
ii) at the end of the reaction the bulkhead is removed, thereby the reaction mixture containing the solid fibres, the BHET, any oligomers and ethylene glycol precipitates in the second section;
iii) by means of the double auger, the reaction mixture is sent towards the third section where the actual pressing occurs inside the tubes provided with a double auger;
iv) the liquid exiting from the holes is collected and sent to step c), while the fibres exiting from section 3 are sent to step b-2) of washing with methanol.

12. Process according to claim 1, wherein when the fibres are still rich in BHET, they are subjected to further step b-3), which is realised in an apparatus consisting of:
A first section comprising a reactor, a mechanical stirrer, heating means, thermal insulation means, a removable cover provided with at least one inlet for loading the reagents and a retractable movable bulkhead, which is automatically removed upon completion of the reaction,
A second section below, arranged along the direction parallel to that of the direction of the first section, placed in direct contact with said first section and, once the aforementioned bulkhead has been removed, being in fluid and solid communication with said first section; said second section comprising an insulated chamber, and a double auger, capable of moving the solid;
A third section arranged along the same direction as the second section and in fluid and solid communication with said second section, comprising two open tubes at the end opposite that of the section and provided at the same end with through holes, each of said tubes containing inside a double auger with reduced pitch and clearance with respect to those of the double auger present in the second section;
said process comprising the following operating modes
I) the first section is supplied with the fibres from the washing b-2) and supplied with methanol at temperatures between 20 and 60° C.;
II) once the bulkhead is opened, the washing mixture passes into the second and then into the third section, provided with augers with greater clearance and pitch with respect to those of the second and third sections when used for steps a) and b1).

13. Apparatus arranged in an inclined position with respect to the support plane of an angle between 15 and 70°, comprising:
A) a cylindrical-shaped reactor comprising:
a double auger arranged along the axis passing through said reactor and driven by a motor outside said apparatus,
in the lower part, a hopper for loading the solid reagents and an outlet where the reacted liquid solution is unloaded into the tank through a special line;
in the upper part: an inlet through which ethylene glycol is pumped from the tank into the reactor by means of a line and, arranged just above such an inlet, an outlet through which the washed and pressed fibres exit by means of a line;
at the top, there are multiple inlets, for the recycling system, placed near the line inlet through which the ethylene glycol and BHET recycling solution taken from the tank is pumped into the reactor. The recycling system can be mixed with the line and inserted into the reactor in the upper section.
B) a compressor to ensure the correct pressing of the liquid and the correct filling of the reactor;
C) heating and insulation means which completely cover the side walls of the reactor with the exception of:
I) hopper;
II) outlet through which the washed and pressed fibres exit by means of the line.

14. Process according to claim 1, wherein step a) and the squeezing b-1) are carried out in an apparatus arranged in an inclined position with respect to the support plane of an angle between 15 and 70°, comprising:
A) a cylindrical-shaped reactor comprising:
a double auger arranged along the axis passing through said reactor and driven by a motor outside said apparatus,
in the lower part, a hopper for loading the solid reagents and an outlet where the reacted liquid solution is unloaded into the tank through a special line;
in the upper part: an inlet through which ethylene glycol is pumped from the tank into the reactor by means of a line and, arranged just above such an inlet, an outlet through which the washed and pressed fibres exit by means of a line;
at the top, there are multiple inlets, for the recycling system, placed near the line inlet through which the ethylene glycol and BHET recycling solution taken from the tank is pumped into the reactor. The recycling system can be mixed with the line and inserted into the reactor in the upper section.
B) a compressor to ensure the correct pressing of the liquid and the correct filling of the reactor;
C) heating and insulation means which completely cover the side walls of the reactor with the exception of:
I) hopper;
II) outlet through which the washed and pressed fibres exit by means of the line, said process comprising the following operating modes:
i) the fibres containing the PET are loaded into the reactor by means of the hopper (and the ethylene glycol and the catalyst are loaded by means of the special line;
ii) in this lower zone (defined as a reaction zone) the fibres containing loaded PET come into contact with an accumulation of EG and BHET so as to be optimally wetted to facilitate the depolymerization reaction;
iii) the depolymerized fibres are collected from the reaction zone and washed in the upper washing area in countercurrent with hot EG and already enriched with the catalyst, allowing not only to wash the fibres but also to complete the depolymerization reaction;
iv) the washed fibres are then squeezed in the squeezing zone, located at the upper end of the machine arranged under the compressor, before exiting the reactor by means of the line.

15. Process according to claim 1 wherein said catalyst is selected from: sodium bicarbonate, potassium bicarbonate, sodium carbonate, potassium carbonate, zinc acetate, titanium oxide, zinc oxide, calcium oxide, aluminium oxide, magnesium acetate, manganese acetate, sodium hydroxide, potassium hydroxide.

16. Process according to claim 1, wherein step a) is carried out by using PET/ethylene glycol-containing fibre ratio between 1.2 and 1.5.

17. Process according to claim 1, wherein in step c) of transesterification the ethylene glycol/methanol ratio is between 0.01 and 0.3, while the ratio of solvent to BHET is between 10 and 15.

18. Apparatus as claimed in claim 13 arranged in an inclined with respect to the support plane of an angle between 30 and 60°.
